(19) United States
(12) Patent Application Publication
(10) Pub. No.: US 2007/0112926 A1
(43) Pub. Date: May 17, 2007

(54) Meeting Management Method and System

(76) Inventors: Hannon Brett, Rancho Santa Fe, CA (US); Gregg Brett, San Diego, CA (US); Mark Strauch, San Diego, CA (US)

Correspondence Address: FISH & RICHARDSON, PC, P.O. BOX 1022, MINNEAPOLIS, MN, 55440-1022, US

(21) Appl. No.: 11/556,420

(22) Filed: Nov. 3, 2006

Related U.S. Application Data
(60) Provisional application No. 60/733,346, filed on Nov. 3, 2005.

(51) Int. Cl. G06F 15/16

(52) U.S. Cl. 709/206

(57) ABSTRACT

A meeting management (MM) system and method is adapted to manage meetings and their output. The MM system provides users a simple way to capture, distribute and archive critical meeting information while providing comprehensive action item tracking and management.

### REFERENCE TO PRIORITY DOCUMENT

This application claims priority of co-pending U.S. Provisional Patent Application Serial No. 60/733,346, filed Nov. 3, 2005. Priority of the aforementioned filing date is hereby claimed and the disclosure of the Provisional Patent Application is hereby incorporated by reference in its entirety.

### BACKGROUND

The present disclosure related to information management and, more particularly, the present disclosure related to a meeting management (MM) system and method for managing meetings and their output.

Meeting and business productivity experts all agree that unproductive meetings can be incredibly expensive for any size of an organization. This is particularly true when critical information and responsibilities derived from those meetings are not captured, tracked and managed efficiently. Often, a person will attend a meeting and collect a multitude of information. The information can include action items, contact information, data files (including audio and video files), key points, decisions, etc.

Although the multitude of information can be useful, the meeting attendees often fail to properly organize and distribute the information after the meeting. In view of the foregoing, there is a need for methods and systems for empowering meeting attendees to automatically capture, distribute, archive, and manage all of the critical information that is shared during meetings, while allowing users to easily assign and track action items.

### SUMMARY

This document describes a meeting management (MM) system and method for managing meetings and their output. The MM system is an easy to use and intuitive software application that gives users a simple way to capture, distribute and archive critical meeting information while providing comprehensive action item tracking and management. The MM system offers demonstrable ROI and complete TCO by empowering organizations to take total control of the critical Meeting Productivity Lifecycle.

In accordance with various exemplary embodiments, the MM system includes modules for:

tracking of action items generated from meetings, including an opt-in system for visibility;

An object oriented approach to meeting management, including actions for participants, meeting files, and meeting notes;

Dependency tracking of action items to take a multi-step, multi-owner action item to completion;

Real cost analysis of meeting data using the merging of accounting data and meeting data;

QuickMeeting paradigm to quickly start a meeting, take key notes and automatically disseminate the meeting data;

Use of “instant” communication (i.e. IM) to instantly create a meeting, get participants and make decisions;

Ubiquitous, non-proprietary meeting output that can display a clear, synchronized representation of a past meeting;

Reports that demonstrate the meeting culture at an organization and suggest clear “best practices” methods to improving that culture;

Live, desktop collaboration during meetings, enabling an entire group of participants to engage themselves in a meeting, leading to clear meeting data at the conclusion;

Providing an understand the “true costs” associated with meetings.

In one aspect, there is disclosed a meeting management system comprising: a desktop application having a plurality of input modules and a plurality of output modules; the input modules including a video input, an audio input, and text input; the output modules including an email output; and the desktop application configured to process video, audio and text related to a meeting from the video input, audio input and text input, and to output a summary email of the meeting to the email output.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a screen shot of an MM system dashboard.

FIGS. 2A and 2B are screen shots of an MM system application interface.

FIG. 3 illustrates a MM summary email setup dialog window.

FIG. 4 illustrates a meeting director summary email (MSDE).

FIG. 5 is a table illustrating exemplary templates for an MM system application.

Like reference symbols in the various drawings indicate like elements.

### DETAILED DESCRIPTION

The MM system enables any meeting stakeholder to capture all structured and non-structured aspects of a physical, phone audio or web meeting, and then distill, distribute and archive core meeting outcomes or products for consumption by any end user. The MM system can be used by any member of an enterprise who wants to hold more effective, productive meetings, while having the ability to easily capture, disseminate and archive critical meeting information.

The MM system is provided via an intuitive interface and workflow. The MM system leverages a multimedia graphics platform, such as Macromedia Flash™ or HTML, as an output format, while providing users with at least those features that offer true value and measurable return on investment (ROI). The MM system is also tightly integrated with and augments conventional electronic mail and scheduling applications, such as Microsoft Outlook™, to enable users to maintain their normal meeting management workflow while instantly increasing efficiency and productivity. The MM system also works with any of a number of audio and web conferencing and communication solutions, to further enable capturing and dissemination of core meeting data.

The MM system includes an Instant meeting set-up wizard, a Start up screen Meeting Dashboard, and one or more Notes Modules. Each Notes Module includes Meeting Details, Meeting Minutes with audio/video sync, user-definable Agenda Items, user Summary Points Module, and Action Items with responsible party reminders through MS Outlook.

The MM system further includes a Summary Email (SE), a structured HTML/ASCII email, with MIME or SMTP email support, that is automatically generated for sending meeting summary data (or a link thereto) via email. The SE can be integrated with any e-mail and scheduling application, such as Microsoft Outlook. The MM system provides toolbar buttons for intuitive meeting scheduling, and MS Office document import (ppt, doc, etc.). The MM system further includes a Sequential meeting keyword/phrase search, an Audio recorder with timing sync, Video feed (lecture) recorder, Live web cam feed with snapshot capabilities, Desktop Screenshot functionality, Desktop presence (system tray access), nonproprietary or ubiquitous output format, Unicode/Double Byte Support, ME Summary Email Auto-Confidentiality Footer, Advanced settings. These and other functional modules are explained in further detail below.

Users set up their MM system one step at a time. Users can click a “next” button to move to the next set up option screen. One or more screens provide the following elements: Interface templates Setting (which fields are displayed on the application interface); Audio/Video Settings (camera and/or microphone set up and use); basic SE output settings; Meeting file archive placement; and Access to advanced features and open first meeting.

In some embodiments, a first screen allows the user to choose from one or more default interface layouts. These include but are not limited to: Business Meeting —with slides; Business Meeting—notes only; or Lectures and Trainings. Users then choose basic audio and video quality settings (three each), preferably via a graphical slide mechanism, and can plug in a peripheral to have that peripheral identified.

Next, users set basic email settings such as choosing between HTML or ASCII output, selecting a basic email design such as general font style and header BG and font color, and setting archiving capabilities and picking archive folder placement. A Meeting File Output Settings screen allows users to select whether to archive outputs files, or to attach media and meeting output files to an email. Users can also choose an archive folder on a server or network.

An Advanced Settings and Open a Meeting screen allows users to access an advanced options menu, or simply utilize all of the selected settings and open their first meeting, i.e. begin a meeting session. If the user cancels out of the Wizard before completing all steps, the MM system generates a message telling the user that they have not completed the set up, and if they wish to fully set up the MM system they should visit the advanced settings via the file menu. Once this message has been given users can click “OK”, which then opens the MM system application with all non-set elements set to the default setting. In the case that a user does not completely set up their MM system application using the advanced settings, default settings are used.

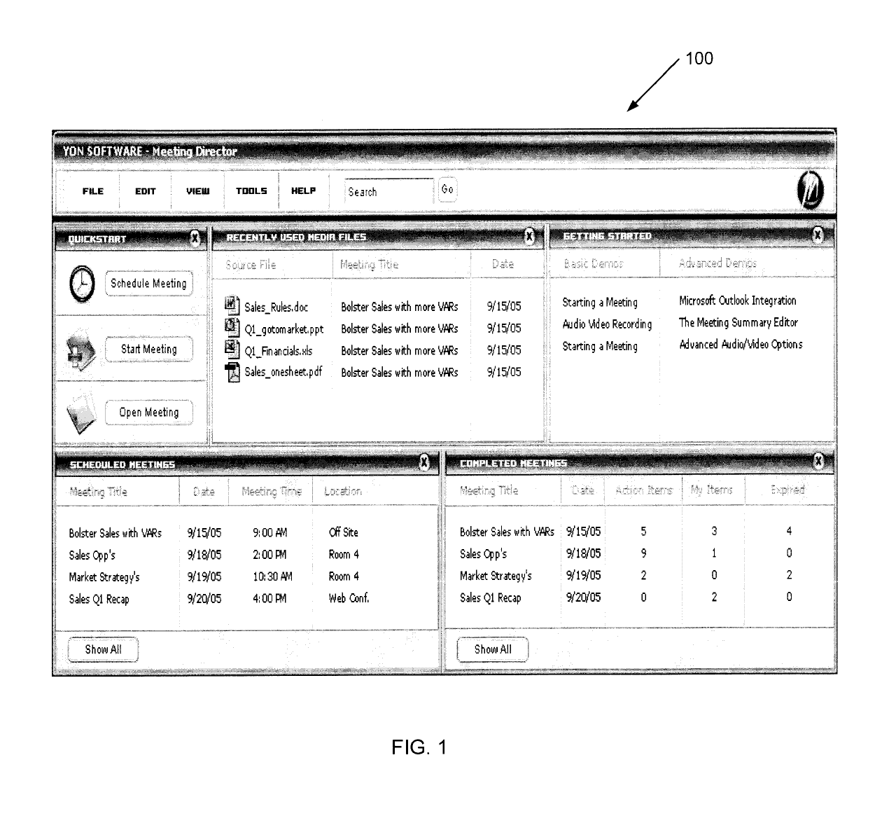

FIG. 1 shows a Dashboard Screen 100 that provides the user with immediate overall access to the following data: View all meetings (Today's meeting, past meeting(s), future meeting(s)), view employees meeting (on the server version if the user is a manager with access to their employee's records), Meeting reports, My action items, my employees action items, as well as other options like Meeting Controls that include: Open an existing meeting; Start a new meeting; or Schedule a Meeting. Each Meeting listing can be represented by one or a combination of the following identifiers: Meeting Title; Scheduled dates; Meeting times; and Meeting Location. The dashboard will also provide access to different meeting reports which are dynamically created based on the information the user is requesting.

The Dashboard Screen also provides an option to display a Number of Future Meetings. Users can choose to display up to a maximum number of Next Meetings (i.e. ten). Each Future Meeting can be represented by one or a combination of the following identifiers: Meeting Title; Date of Meeting; Action Item Number; and Action Items assigned to a particular user.

The Startup Dashboard Screen also provides an option to display: Important documents previously linked to or used in meetings; a Promotional area (i.e. Buy now—for trial users, or Buy for the entire organization—for customers); and/or Various links to online help and “getting started” videos or graphical instructions.

Users can add some level of customization to the meeting Dashboard view, to provide users with the ability to individually set the number of both Past as well as Future Meetings that are displayed when the Dashboard Screen is opened. Settings are accessible via the Options section of View the Menu. A maximum number of meetings a user is allowed to show on the interface without the need for scrolling can be set, and a default number of meetings shown for both categories is five. The user can also click a “See all meetings” link to show all Future Meetings and a number of Past Meetings. This link activates a display field that turns into a scroll box to display all meeting listings (up to a set maximum).

Dashboard Behavior

Future Scheduled Meetings-Users can access an e-mail/scheduling application's (such as MS Outlook or Lotus Notes) meeting records that have been scheduled for future dates via the dashboard. These listings allow the user to see the meeting's actual record with information like; title, proposed date, proposed time and location of that meeting. If the user director clicks on the meeting's title, the MM system accesses the associated meeting record in the user Outlook calendar.

Within the Past Meetings listings, users can see a listing of their Past Meeting titles, the dates of those meetings, how many Action Items were set, how many have expired (due dates and/or reminders), and how many of those action items are attributed to a particular user. A meeting's title provides a link that takes the user to that past meeting's associated SE output, which then provides users with a complete vision into that meeting's data capture.

Interface modules are fields in the MM system application that capture a meeting's critical information in the form of the following inputs: Audio/Video, Agenda Items, Action Points, Summary Points, slides, General Meeting Information and Meeting Minutes. Data that is recorded and disseminated based on these inputs provide the basis of a successful, productive meeting. The MM system structures and formats this data for easy end-user consumption. Users can choose between Meeting, Presentation and Lecture interface layouts from the set-up Wizard, and via the View Menu. The standard interface layout is the Meeting Presentation layout, which displays all available modules.

The MM system application interface is resizable to any size within the user interface display area. A user can click in an area of the interface, i.e. the lower right-hand corner, and “drag” the interface bigger or smaller. The modules automatically change size to accommodate the overall window size change. A minimum size default can be set that inhibits any window from being sized too small.

Once the user has selected a specific layout (or has kept the standard or default layout), the user can then manipulate the interface by either closing or expanding any of the modules. These processes are explained in further detail below.

Expanding Modules

Users can expand any single module at any time to get a magnified view of this module. While expanded, each module will function as it normally would. To expand a module the user simply clicks on the “double boxes” (as in any MS window) at the top right of each module. When any specific module is expanded it will grow in size and be placed into the middle of the interface with the focus on that module. The expanded module can be dragged and dropped to any location within the interface. While a module is expanded, the user can use the other modules (as long as they are visible). Only one module can be maximized at a time. To return the expanded module to its original size and place, the user simply needs to click the double boxes again.

Customizing the Interface

In order to allow users to completely customize the user interface, modules can be “dragged and dropped” around the interface in order to create a customized interface layout. Each module can “snap” to a grid in order to allow sizing and moving of modules around the interface until a suitable position is found, and so that modules can be lined up quickly and easily.

Sharing Customized Layouts

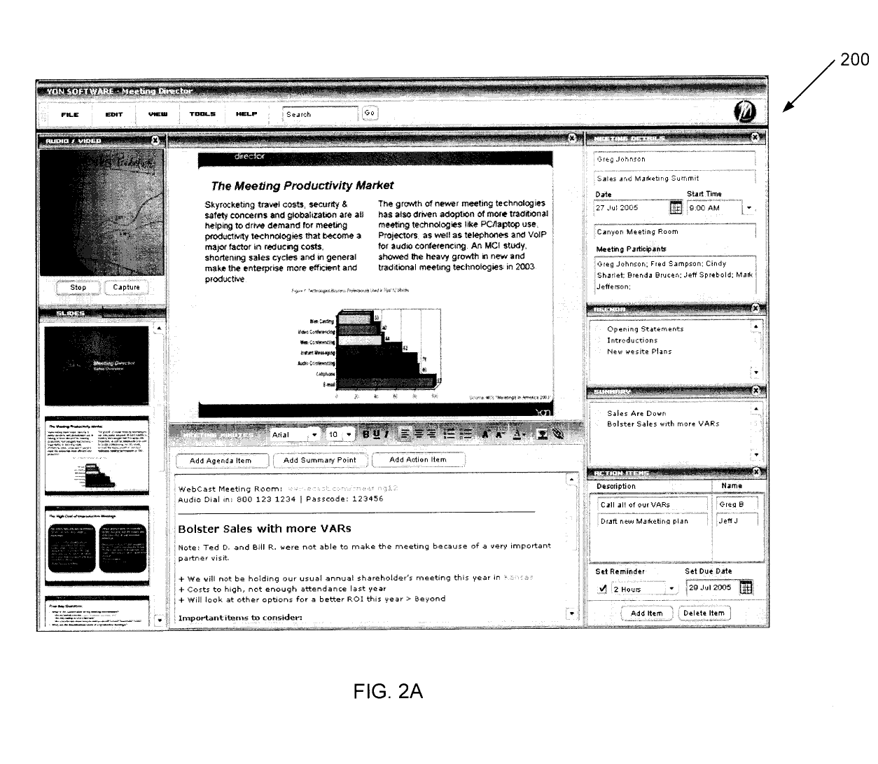

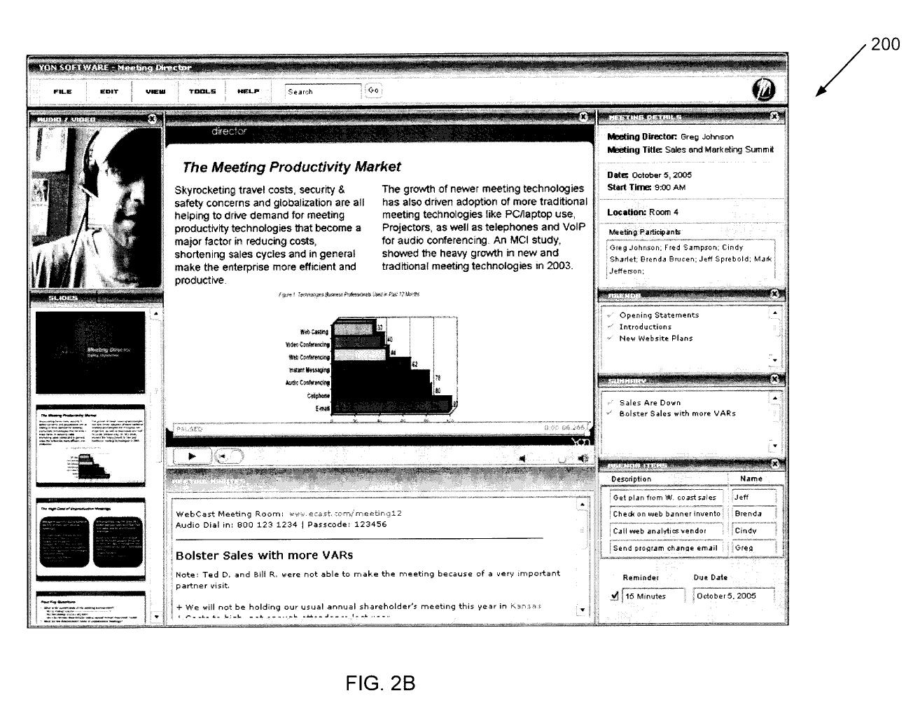

FIGS. 2A and 2B show exemplary embodiments of a meeting director application interface 200. Users can share customized layouts via a distributed XML configuration file. When a user has customized the Meeting Director interface by dragging and dropping modules, resizing, and adding and closing modules, they can share this layout with any other (or any size group of) the MM system user(s). Those who receive the XML interface configuration file can be sent to other users via email for download into a specified folder on a hard drive. This configuration architecture enables an organization to distribute corporate “meeting rooms” in the MM system. The next time a user opens the MM system, they are prompted to choose whether to use the new interface, as well as to choose whether they would like to use this new interface as their default interface. Once they have accepted the interface that was sent, that interface is used until the user customizes it or chooses another interface template.

Closing Modules

To further allow users to customize the interface, any MM system module (except Meeting Details) can also be closed at any time. Users simply click on a “close” button or icon, such as the “x” icon in any Microsoft window, in a module, which closes that specific module. Once a user closes a module, the module below or to the side of it is moved to replace the space left by the closed module. Once a module has been closed, users can reopen it by selecting the module again from the View Menu. Selected modules are associated with a “check” mark in the View Menu. If the module contained content at the time it was closed, that content is stored until the meeting is closed in case the user decides to reopen the closed module. Users can reopen closed modules anytime during a meeting to display the content again. If the module is not reopened while the meeting is still open, its content still appears in the final meeting file and in the SE, unless taken out via the SE chooser dialog during a closing process for the meeting.

Messaging

If the user chooses to close any module, the MM system generates a message to ask whether they are sure they want to close the module. If there is content in the module, a warning is shown to let the user know they are about to close a module currently containing content. The MM system retains the content of “closed” modules and includes the content in the SE, if specified. A “do not show me again” type message can be generated for a checkbox.

Module Title Customization

Users can change the titles of the two unlinked (to Outlook) structured notes modules that are defaulted to Summary Points and Agenda Items. With a customer Outlook form, the Agenda is also stored in Outlook and linked. The MM system gives the user flexibility to create their own custom modules and give these modules any name they wish. The MM system also allows users to choose the “type” of module, with options including bulleted list, numbered list, rich text control, etc. Preferably, these two module titles arc changed with a double click on their titles and typing new titles into these fields. Once the user types in new titles and clicks off the area, the new title is put in effect and is echoed in the output file as well as the SE. These titles can also be changed in the Options Menu, or simply be left as their default titles. Title changes do not effect how these modules function.

Interface Status Bar

The interface status bar shows a few general user data points. These data points are visible throughout a meeting and are displayed along the bottom of the interface.

Slide Count Status

This information displays the slide number out of the total number of slides that is currently being displayed. Thus, the layout is provided as “Slide X of XX”. This information is displayed to the left-hand side of the status bar directly under the slide thumbnails.

Audio/Video Recording Time Status

This status shows the running recording time of the audio/video Module in hours and minutes, and runs as MM system records. Anytime the audio or video is stopped while in a running meeting a symbol such as a small blinking red octagon flashes after the title of the type of stoppage, either “Audio -” or “Video”. This symbol is also be displayed in the meeting output file as it is recorded.

Meeting Details Fields

These fields record a meeting's basic demographic information. This grouping of input fields may not be closeable or expandable, but can be left blank when desired. While some of these fields are merely text input fields meant to record simple information, some fields are “intelligent” fields that are linked to the customers LDAP or Active Directory database. These fields include the following:

| Meeting Details | Lecture Details |
|---|---|
| Meeting Director | Lecture Title |
| Meeting Title | Lecture date |
| Date | Start Time |
| Start Time | Class Title/Section # |
| Location | Professor Name |
| Participants (LDAP/AD tie-in) | Lecture Location |

Meeting Attendee Field

The meeting attendee field allows users to type in the name of any employee currently held within their LDAP or Active Directory listing, or any complete “out-of-house” email address. If an email address is an LDAP or AD entry, the MM system completes the name with the appropriate email address. Names are separated by a semi-colon “;”. This field ties in to a company's LDAP or AD system to ensure that all changes made to the companies overall LDAP/AD listings will be echoed in the MM system. If a name entered is not a company employee, that name appears with an indicia, such as red underlines, signaling that the name was not found in the directory. If the user wants to add non-company names, they can do so by entering the full email address (ex. Joe.Smith@companyxyz.com) using the standard email protocol including semi-colon separator(s) between addresses. There is no limit to the number of email addresses this field can hold. Once the addresses have grown past the set box size, this field turns into a scrolling input field.

A Meeting “Participant” module can be used with all the participants in place of the meeting details module. The other “details” will be distributed throughout the user interface. The “Participant” module will enable quick access to actions that are specific to a participant, including assigning action items, sending an email or IM, removing from the meeting, etc.

Date Field

The existing PIM is used to generate the date for the date field.

Start Time Field

The user can either directly input a specific time, or click a “down” arrow to display a 24 hr clock from which to choose a start time. Selecting a time from the dropdown places that time into the open field. Time fields are split into two fields; one for the hour and one for minutes. In some embodiments, a “start” and “stop” button is provided for accurate time keeping, and therefore accurate time reporting and tracking. Alternatively, the minutes field includes only 15 minute increments (:15, :30, :45, :00), but can allow users to input any customized time (e.g., 33) by typing directly into the field.

Meeting End Time

When the meeting is closed by a director of the meeting (“user director”), the MM system automatically logs an end time that is shown in the SE, and at the bottom ‘status footer’ in the final meeting output file. Meeting start and end times are displayed on the bottom status bar in all meeting output files, and in the meeting details area in the Director's Summary.

Structured Note Fields

Structured note fields differ from the detail fields in that they inherently contain and apply visual and structural controls as the user inputs data into these fields. These structured notes are then repurposed for the Director's Summary Email. Each structured note field allows the end-user to add or delineate between separate, individual agenda items, critical summary points, and actionable items within the field (in order to set the new item apart from the previous items). The information contained in these fields becomes the core data disseminated to end users through the Director's Summary email, and via the meeting ‘playback’ output file itself.

Agenda Module

The Agenda module allows users to define a list of agenda items for any meeting simply by typing into this open module. A structured graphic element (symbol) precedes each agenda item in order to denote a new agenda item. This graphic element carries through to the SE. When a new meeting is opened and this field is blank, the MM system automatically places a standard symbol in this field to let the user know where to start. The default symbol for this module can be a round, closed black dot. All entries automatically have a space between the symbol and the user's text. Users can customize symbols by right-clicking on any of the symbols in the module and choosing from a number of symbols including, but not limited to: open dot, closed back dot, checkmark, closed black square, or custom.

Changing the symbol for one agenda item automatically propagates the symbol to the whole field. As the user types, the text wraps if needed. If a single agenda item wraps to more than one line, only the first line has a preceding graphic element. If the user hits the hard carriage return, a graphic symbol is placed on the line below it. This new symbol denotes the start of a new agenda item.

User should not be able to change the title of “default” modules, i.e. Agenda, Meeting Minutes, Summary Notes, etc. Only custom modules can have user-defined names Users can customize the title of this module by double-clicking in the header area and typing in a new title. Meeting Agenda Items, which are filled in at the time the user schedules a meeting in Outlook using the MM system tab, populate the associated meeting. If the user wishes to change the pre-filled Agenda Items at the time of the meeting, the user simply edits them as they would any other content.

Meeting Summary Module

The Summary Points Module can also be linked to header creation in the Meeting Minutes Module. When a user creates a header in the Meeting Minutes module that header will also be placed into this module as a new Summary Point. These header summary points can then be manually edited by the user via traditional word processing means. Users can also choose to disassociate these two elements and will be able to do so in the Options Menu. They will be linked as the default. (for more detail see Applying Headers within the Meeting Minutes Module below). As mentioned above users can also customize the title of this module by double-clicking the header and typing in a new title.

The Action Item Module requires that new items be manually added, or highlighted and deleted via buttons at the bottom of the module. In order to add a new action item, users click an “Add Item” button. The responsibilities field can also be linked to the user's LDAP or AD system. Users can input more than one name per action item, and can also add full email addresses for those not in the company. To delete an item, users first click on the specific item to highlight that item, and then click a delete button. If the user chooses to delete an action item, a message is generated to ask whether they are sure they want to delete the action item forever. A “never ask again” checkbox can also be provided to the user.

Non Inter-Company Action Item Assignment

Meeting attendees that have been assigned action items but that are outside of the user's company can still receive Action Item notification. Those not tied into the user's company's LDAP or AD system (and thus not eligible for MS Outlook reminders or tasks programming) can still be assigned their action items through the SE listing. While not be pinged via Outlook reminders or Tasks, they see their name next to an action item in the SE, which can be used to track responsibility.

Urgency Flags

Users can set the importance of each separate action item via an intuitive right click menu that allows the user to designate an action item as urgent, i.e. place a colored red flag before an individual action item. In the right-click menu, the urgent designation can be accompanied by the word “urgent.” If an action item has an urgent designation associated with it, any reminders or emails that are sent to the item recipient also carry the designation. Dependent action items are provided and managed such that one action item can be tied to another's completion.

Assigning Responsible Parties to Each Action Item

Each time a user creates a new action item in this field (via the prescribed methodology mentioned above), a field to assign a responsible party accompanies the new item. These fields act similarly to a meeting attendee field, in that this field allows users to add complete email addresses or pull names from a company LDAP or AD database. A user can prescribe more than one address per action item.

Setting Reminders for Assigned Action Items

At the time each action item is created the MM system can also generate Outlook reminder “pings” for recipients of that item. When a reminder is assigned to an action item, a check is placed in the open checkbox next to that item (denoting that a reminder has been set). For each action item, the MM system can set one, two, or a recurring number of specific Outlook reminders. If a recurring reminder is chosen, the second reminder input box is disabled so that the recurring reminder is based on the first reminder time period. In an example, the reminder time period choices can be 1-6 single days (1 Day, 2 Days, 3 Days, 4 Days, 5 Days, 6 Days), 1-3 Weeks, 1-11 Months, 1 year, etc.

Users can view which reminders have been set for each individual action item simply by clicking on that item. When an item is highlighted, the reminder criteria are displayed in the appropriate reminder fields. Users can also add due dates for reminders that are displayed in the reminder itself.

Action Items Setting Tasks in Outlook

Users can determine whether action items also get populated as Outlook Tasks via a setting in the Options Menu. Once a reminder has been programmed, this information is transferred to set an MS Outlook task with the responsible party, the due date, and appropriate reminders within MS Outlook.

Meeting Minutes (Notes) Module

The Meeting Notes field is where much of the granular and “free-note” meeting information/discussion is recorded. This module provides simple yet powerful word processing functionality such as like Microsoft Word. Lists function as closely to MS Word's workflow as possible. Each structured note element can also be automatically correlated to corresponding slides and audio/video recordings in order to allow for synced or non-synched meeting playback or item/element access, as described in more detail below.

Drag and Drop

The MM system uses this module as a catch-all for unstructured meeting notes and other peripheral elements such as website URLs, digital graphics media and MS office document content. Thus, a user could be browsing a website in the background and can drag a graphic from the website and drop it into the notes field of the Meeting Minutes module. Users can also input literal URLs as well as embedded text URLs into this module. Finally, users can drag and drop highlighted content from other modules as well as from open MS Office documents directly into this module.

Applying Headers within the Meeting Minutes Module

While most text within this field is rich formatted text, graphics, and URLs, “header” tags may need to be applied to specific text items. Headers can be used to structure and design automatically generated and formatted HTML or ASCII email summaries. Applying headers allows the user director to set important meeting information separators. When a user director wants to create a new segment or header in the minutes notes, they can either click a “Create Header” button on the Meeting Minutes Module toolbar, which places a header style directly into the text of the Meeting Minutes module, and then type in the header, or they can highlight an existing line or word and click the “Create Header” button which then turns the text into a header.

Headers are called out in the Meeting Minutes text, as well as in the SE via larger, bold font. All other formatted text will fall under each separate header. When users create a header within the Meeting Minutes module, that header is automatically auto-populated into the Summary Points module in the order entered. Users can then manually update the summary point by editing the text.

Summary Email (SE)

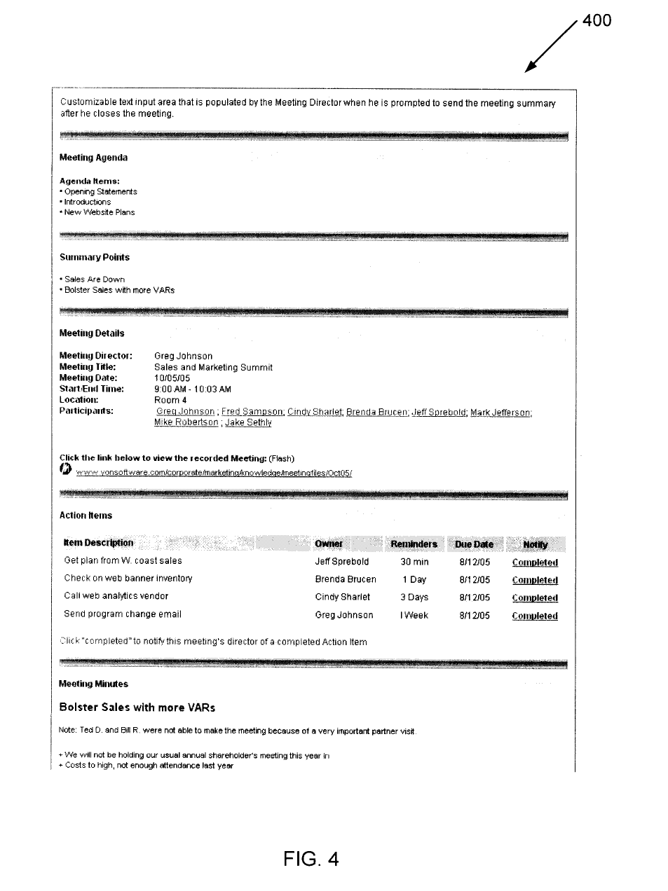

The SE clearly captures and translates all critical data generated from a meeting's structured and unstructured note fields. FIG. 4 shows an exemplary SE 400. The SE is a formatted and customizable email summary that provides end-users with a concise, easy to read encapsulation of chosen meeting data. As mentioned before, a user can choose which modules, as well as which data contained within those modules, to include in the SE. The default data points that are included in the SE include: meeting summary; meeting details (director/lecturer, title, date/time, place, attendees, etc . . . ); actionable items—with associated responsible parties, reminders, due dates, urgency flags, and “completed” mailto link; agenda items, included Meeting Minutes Notes (optional add); links to slides, still shots, associated documents, etc.; and a link to the complete meeting file hosted online or attached SWF document.

Since the email output depends on the content added during the actual meeting as well as what users choose in the SE, email content is defined by which modules were actually used. Modules that have not been used or filled in with content are not translated into the email.

SE Designer

This dialog will appear when a user director closes a meeting and is ready for the MM system to send the automated summary email. This dialog allows users to do the following: add a salutation text; add or change summary email recipients (by default all meeting attendees will be included); select which module to include in the summary email; determine the vertical position of each module; and not view the dialog again (i.e. use defaults for all modules). The MM system will utilize an e-mail format the user has specified as default in their PIM. Alternatively, the user can select the email output format (HTML or ASCII).

Salutation Text

The top field on the chooser dialog allows the user director to add customizable salutation text that will appear above all meeting data in the SE. This content will allow users to provide any type of background, summation, and/or salutation to recipients of the SE.

Add/Edit Summary Email Recipients

This is another LDAP/AD enabled field that re-lists the emails of the attendees originally given for the meeting. This field allows users to delete those names that they do not want to receive the SE, or add those who should receive the SE but who did not attend.

Email Output

An Email Output button allows a user to choose a preferred email output format. If the user chooses HTML, the design that has been set will be applied to this email. If no settings are chosen, the default settings are applied.

Module Chooser

This field allows the user to select the order in which the Modules are displayed in the email, and also enables the user to hide a module so that it is not included in the SE. Modules are moved by clicking on the desired module title in the Chooser field and clicking the “Move up” or “Move down” button in order to move the module title into the correct position. Modules are shown in the order they are displayed in the Chooser field. When Modules are chosen to be hidden, the user simply clicks on that module's title and clicks a “Hide” button to “gray out” the selected title so that it does not show up in the SE. Users can “unhide” any hidden module be repeating the same process.

Chooser Disable Field

Users who do not want to be presented with these options every time they close a meeting can choose to check a “Don't show again” check box provided in the window. This will ensure that when a meeting is closed, from that point on the Chooser dialog will not show up and the default settings are used. Default settings include settings that were chosen when the Chooser was last used. If the chooser has never been used, the MM system will simply display all modules, link all media, and send the default designed SE. Users can turn the Chooser back on via the Options Menu. If the user chooses to not show again, the MM system generates a message to ask if they are sure and to let them know that they can access the Chooser via the Options Menu.

SE Action Item Field Details

In the SE, the Action Items field are arranged and emphasized to enable consumers of the email to get a complete view of: Meeting Action Items; Responsible Parties (linked email addresses); Set Reminders—for each item; Due Date; Urgency Flag; and Completed Action Items Notification.

Completed Action Items Notification

This “mailto” link at the end of each Action Item enables users with MM system Action Items assigned to them to send the MM system an email letting the user director know that a user has completed their Action Item. This link is a “mailto:” link that opens up a new email message with a pre-filled recipient, subject line and body content. The new email is automatically addressed to that meeting's director/user; automatically fills the subject line using; “<Name of sender> has completed the following Action Items”; fills the body with the complete Action Item line found in the original SE; and provides a link back to the hosted SE (if hosted). The sender can then add, edit or change any element of the SE, and will simply click to send all of the elements mentioned above to the intended recipients.

Meeting Director Summary Editor

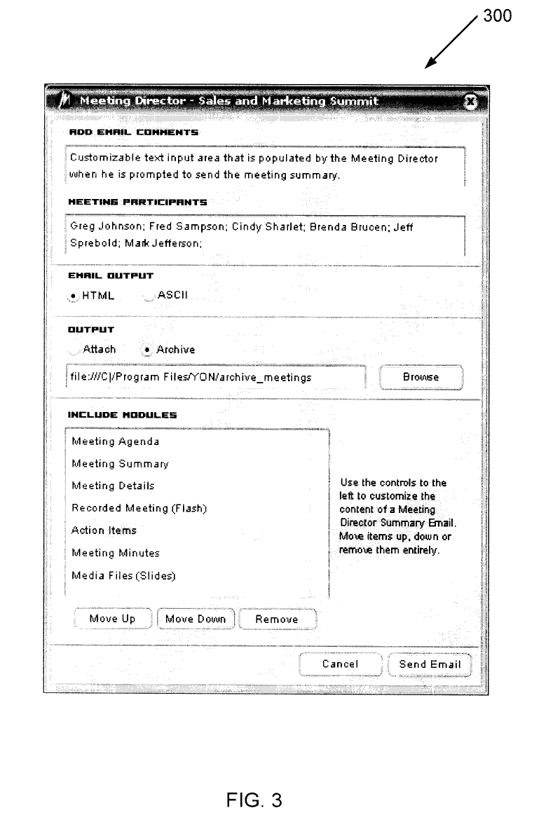

FIG. 3 illustrates a Meeting Director Summary Editor dialog window 300. Through the Meeting Director's Summary Editor, users select the ability to send an HTML or an ASCII email summary. They can also influence/customize certain visual aspects of the HTML summary email. These capabilities apply to the entire summary email, thus settings are “template-wide” customizations, i.e. users cannot change individual item/words/sentences/paragraphs/etc., and therefore these settings act as an email output style guide. Settings that can be changed via the editor include: selecting HTML or ASCII email output; choosing a header (i.e. font, font color, font size, and background bar color) or general text; email subject line settings (Subject line title base such as meeting title and date, only title, etc.; Summary Elements to include/exclude (i.e. associated (uploaded) documents, media Such as video, audio and screen grabs and still shots); or add a logo to the email with an auto-footer with confidentiality statement.

Confidentiality Auto-Footer

The MM system automatically adds a customized confidentiality footer to all SEs. This functionality is accessible via the ME Summary Editor in the Options Menu as a simple cut/past or type in field. If the user opts to use the confidentiality footer, the text they input is placed at the very bottom of the SE.

Brand Customization

Users can add a logo to all HTML SEs. Logos can limited to a particular size (i.e. 70×70 pixel size logo at 72 DPI, at no more than 15 KB). Users can upload graphics directly from the Editor dialog.

MIME Email Support

As noted above, the MM system feature automatically inserts and sends a customizable, formatted and structured meeting summary within an email to any number of recipients via that users current email application when a meeting is closed (or exited). This auto-send capability can be turned off in the Options Menu from the File Menu.

The MM system can instantly insert a compressed SWF file of all meeting elements (including audio, video and slides) into a blank email message with a pre-filled subject line (the file uses the meeting title given by the user, or be customized). The user clicks a “send email” toolbar button directly from the MM system application interface or from the File Menu. From there the user cam choose to either send the entire file or just a link to the hosted file (users can set up hosted access in the Options Menu).

MS Office Document Support-Drag and Drop to Flash

The MM system supports drag and drop (or upload) conversion to display documents as meeting slides in universal multimedia format, such as Flash, to utilize document types that users use most when holding meetings. While the setup wizard allows users to upload a document for their first meeting via traditional methods, subsequent use allows users to simply drag and drop any MS office or RTF-based file, particularly a PowerPoint file, into the user interface to convert that document to Flash as a part of the meeting/lecture slide deck. Any time a file is dragged and dropped onto the interface or is uploaded to this meeting occurrence, the icon type of that file as well as the title of the file is displayed in the “Files” tab of the Slides and Files module. From this pane, the user is able to double-click on that file name to open the source document in its original format.

Dragging and Dropping Slide Content without the Slide Module

If a user director inserts MS Office documents into the interface when the slides module has been closed or is not currently being displayed, a message is generated asking if the user would like to either, 1) open the Slides Module and convert the content on the fly, or 2) add the file to the meetings file repository and to the slide thumbnail row. Any time a file is dragged and dropped into the interface, a progress bar is displayed showing the how much of the conversion has been completed.

Drag and Drop MS Word/PowerPoint Content

Users can cut and paste or drag and drop all text and graphics based content from within MS Office documents into the meeting minutes module. Text-only content can be dragged and dropped into any structured note field. Also, once these documents have been converted into Flash content in the Meeting Director Slides Module, that content should also be insertable into other note modules for reuse. Content can be taken from any module and placed into any of the other modules via a simple drag and drop or cut and paste, particularly if text only.

Slide Deck Behavior

The MM system provides a selection between two slide modes:

1) synched, for recorded structured meetings and lectures; and 2) un-synched, for general business meetings. In un-synched mode the Slide deck behaves like PowerPoint and will operate independently of the timed audio/video recording. Users can drag and drop any slide to a different position within the deck, and delete any slide by clicking that slide and selecting the delete button. Users can create copies of slides by selecting a specific slide and then “control-C, control-V” while the focus is still in the Slide thumbnail area. Any time a slide is chosen for deletion a message is generated asking if the user is sure that they want to delete the slide. A checkbox is also displayed saying, “Don't ask me this again”.

Synced Slide Mode

In synced mode, slides and other structured notes fields are directly tied to time stamped audio/video recordings of the meeting. Thus the core driver of these meetings is timed Audio/Video recordings, and everything else will sync to those elements. Sync mode can also be used if the Audio/Video Module is not in use. If this is the case, the Slide Module itself is the driving sync point of the meeting output.

Once the sync-point for a meeting is defined (either Audio/Video or the Slide deck) the notes that were input into all other fields during the meeting correspond to the sync point so that all content originally recorded during a period of time is displayed in the playback as the user moves either the slide bar for Audio/Video or navigates through individual slides. If the Slides Module is the sync point, slides cannot be moved or shuffled as other notes content is directly tied to each slide. Users can use an “enlarge module” function to maximize the size of the slide deck for views.

Unsynced Slide Mode

In unsynced mode, slides or Audio/Video run independently of everything else, thus other meeting content is not linked to a central Module. In this mode, all slides, audio/video and notes are completely free of one another and can show up independently in the playback file.

Meeting Content (Textual) Sequential Keyword/Phrase Search

This feature allows any user to easily search all textual content of a meeting for specific words or phrases. This feature enables end users to quickly find specific topics, agenda items, or simply cue on contextual information within any length meeting. The search is instantly accessible via the meeting interface, and includes a sequential search for all use of a word or phrase within that meeting.

Audio/Video Recording

The MM system provides meeting stakeholders a simple way to capture meeting audio and video via a laptop's built in microphone and/or an installed PC camera, or via more advanced peripheral equipment. Recording is intuitive and easy to use directly from the MM system application interface. The set up wizard allows the user to set up a set of “most used” optimized recording and audio settings without the need for further tweaking. Advanced settings are made available to advanced users via the system tray and the Advanced Settings found in the Options Menu. Users can also select to close the Audio/video recording module by clicking a close icon, such as an “X” at the top right. Closing this module brings the Slides/Files module up to take its place (extending all the way to the bottom of the interface, even if there aren't enough slides to fill the entire area). Advanced Settings enables the user to configure specific elements of more complex audio/video recording.

Audio/Video Meeting Controls

Clicking the “Start Recording” button starts an attached video input device and begins recording whatever the camera has been set up to capture. Once a user has clicked the start button, this button label changes to show the words “Stop Recording”. If this button is clicked again, the camera stops recording. Users can toggle between the start/stop controls without causing disturbances in the final video when viewed in playback mode. This feature enables users to quickly and easily turn the video recording and/or audio recording off during periods where video is not desired. A clock feature giving hours and minutes of recording time is displayed (i.e. in the bottom right-hand corner of the video recording screen) while recording during a meeting. This clock can be displayed in the playback video area while the video is played back. This timer can start and stop with the start/stop functions and will not “skip” because of starts and stops.

Recording Devices and Behavior

Recording automatically takes place through either the computer's built in microphone or through any peripherals that have been plugged into the machine at the time of recording. The MM system automatically detects any peripheral devices being used, and seamlessly utilizes these devices for recording. The MM system automatically applies the audio/video settings that have been set by the user. If no settings are chosen, the user director automatically picks the most optimal settings so that the user does not have to take any action to start recording. These settings ensure good quality output with the most efficient file output sizes.

Advanced Settings

Advanced settings are simple and sparse, and use best measures to capture data and make file sizes as small as possible at the best quality. Users are offered the ability to change the most important functions. Settings include two recording quality “slide bars” and two or three check boxes, as well as an area for manually choosing an input peripheral. The two slide bars include an Audio Slide bar (with Loud, Louder and Loudest settings), and a video slide bar (with baseline, high and highest settings).

Screen Shots and Camera Stills

Users can either take an instant screen shot of their entire desktop or only of a window currently in focus. Users can also take a single “still shot” of whatever the peripheral camera is currently recording (whiteboard, projection, etc.). When a user takes a screen grab or still shot, a camera sound is generated and played to let the user know that the shot has been taken. These elements are automatically added into the current meeting slide ‘deck’ at the spot/time the shot was taken. If users decide not to use the shot, they can simply click on that ‘slide’ and then hit the delete button.

WebCam Still Shots

The Audio/Video module offers users the ability to instantly take a still shot using the attached webcam peripheral by clicking the main area of the “Capture” button next to the Audio and Video start/stop buttons. As mentioned above, all still shots are instantly added into the slide deck after the current slide in focus. Once the still has been taken, the slide deck focus jumps to the still shot, from which users can shuffle the still in the deck or delete it.

ScreenGrabs

Screen Grabs can be taken of either the user's entire desktop, or of a particular open window on the MM system application interface. To do either, the user uses the same “capture” button next to the Audio/Video start/stop buttons, but now clicks on the right-hand corner of this button (denoted by the sectioned off area with a ‘colon’). Clicking in this area causes a drop down menu to appear. This menu allows the user to chose between taking a screen grab of their entire desktop (behind the Meeting Director focus), or of a single open window. If the user chooses the entire desktop, the MM system takes the screen grab and adds it to the slide deck in the same manner as mentioned in the WebCam Still Shot section above. The user can choose the appropriate window by clicking on that window. This adds a screen grab of the chosen window into the slide deck in the same manner as above. Manipulating grabs and still shots is functionally similar to any other slide in the deck.

Meeting PlayBack File

The basis of the meeting playback is the output file format. This output is preferably in the Flash/Flash Video format so that all elements (i.e. text, MS Office documents, audio/video, peripheral source media files) can be delivered and shared in a universally accessible, compressed, and easy-to-view format. Users can also search the output meeting file for keywords and phrases.

The playback file looks similar to the user director's view, but is missing all module configuration controls, input fields and actionable buttons. Another big difference is the playback controls and slide, as all meeting files allow the user to move through files of Audio/Video recordings or a slide deck in a timeline fashion, with rewind, fast forward and a slide bar to move between Audio/Video and slides.

Playback in Synched Mode

In synced mode, the playback controls and slidebar manipulate all aspects of the meeting at once, as they were recorded. The controls are anchor-synced to the slides or the audio/video.

Playback in Un-Synched Mode

In un-synced mode, the playback controls and slide bar manipulate only the slide order or the audio/video. All notes areas in this mode are free-standing and are not effected by the main controls.

Desktop Presence-System Tray Access

The MM system provides easy, immediate access to key elements of the application via the system tray. During the installation process, the user can select whether or not to install system tray capabilities. The ability to turn system tray capabilities on/off is accessible via the Options Menu. The system tray icon allows for instant access to the following functions:

| Functionality | Action |
|---|---|
| Start Meeting | Open the MM system interface |
| Stop Meeting | Stop meeting - open SE prompt window |
| Recommend to a friend | Send a URL in an email |
| Buy Now (Trial only) | Direct link to OLS |
| About | Link to about file |
| Help | Link to help file |
| Turn sys tray access off | Turn off icon |

The MM system supports unicode and double byte characters in order to allow for quick, easy and affordable localization in the future. Using a multimedia web content format such as Flash as a core output format enables the MM system to leverage the ubiquity of the format and player to drive optimized meeting information access with the highest level of pass-along without barriers. For example, a video format such as FlashVideo can be used for recording video via web cams or video recorders. This highly compressed video format allows the entire recorded meeting file to be passed along to any users who can view a Flash file in a highly compressed manner.

Microsoft Outlook Integration

This encompasses the track and responsibility management piece to provide Outlook users with an add-in toolbar button that allows users to easily access specific elements of the MM system. The integration adds an extra tab within each meeting record to allow for the addition and dissemination of structured meeting information via the meeting invite. Finally, this integration also allows users to set Outlook Reminders and Tasks with due dates directly from the MM system application interface.

Outlook Add-In Toolbar Integration

When a user installs the MM system, the application also installs a toolbar button into the MS Outlook interface. This toolbar button is accessible from the main Outlook Calendar interface, while specific meeting records show an extra tab that allows users to input specific MM system data. Clicking the MM system button from the main MS Outlook interface drops down a list of available options, including the following:

The first feature accessible via the button's drop down menu is “Schedule Meeting” which enables the user to open a blank Outlook meeting record. In an embodiment, this record will not have any automatically filled in information, but opens to a 30 minute noon-time meeting. The user can fill in all necessary information as well as change the default time of the meeting if desired. Other default times and durations are possible in other embodiments.

The second capability on this list is “Access Dashboard” which allows the user to open the MM system to the Dashboard screen in order to provide a view of their scheduled and past meetings. The dashboard displays the chosen setting, or the default settings if none have been chosen.

The next selection is “Preferences”, and allows users to access and set/reset the MM system controls while still having MS Outlook open. Clicking this selection opens the Options Menu dialog over the MS Outlook window. The “Meeting Director Help” choice, which can be labeled “Help,” opens the F1, contextual help hosted within the application itself. An “About Meeting Director” option opens an informational box. This box displays conventional “about” information.

MM System Meeting Record Call-Out

On the MS Outlook main Calendar interface, all scheduled MM system meetings are denoted by a small logo at the far right-hand corner of the meeting record. This workflow allows users to schedule meetings simply by adding an additional meeting record tab to the meeting record interface.

From Within A Newly Opened or Pre-Existing MS Outlook Meeting Record

When a user opens a new meeting record, or accesses an already created meeting record, that user can fill out all the traditional information found on the two main tabs (“Appointment” and “Scheduling”; and “Tracking” once meeting invites have been accepted), but can also access an additional “Meeting Director” tab (installed with the software) in order to input MM system enabled information. When a user un-checks the MeetingDirector box in any Outlook meeting record, a warning message is generated to inform them that this meeting's information and listing will not show up in the MM system application interface. Users can also view and select “Don't show me this (message) again”.

Meeting Type Designation

First, the user director selects whether a meeting will be an MM system meeting. This means that the meeting will be listed within the MM system dashboard, and the agenda items input into the Outlook meeting record will be carried over into their MM system Agenda Items Module. By default, this box is checked and can be unchecked if the user does not want it to become an MM system Meeting (casual or not official meetings are a good use case for this feature).

Outlook and MM system Sync Times

In order for the MM system to open with information inserted into the Outlook meeting record, the MM system opens with the data from a certain meeting already in place. The timing of the meeting determines when this information is imported into the interface. For example, if the meeting was scheduled for 3:00 on Friday, that information will be automatically imported into the MM system application interface anytime after the official meeting time. Any time that a user opens MM system application after that meeting time, yet before the next meeting time, that specific content is populated into the appropriate modules. If another meeting is scheduled 30 minutes later, and the user opens the MM system application any time thereafter, the new meeting data is populated.

Outlook Meeting Information Import

All other information that has been selected via an Outlook meeting record is imported into the MM system at the time of a scheduled meeting. The following data is taken from the Outlook record and placed into the MM system application interface for that meeting: The Meeting Director Scheduler; Meeting Subject (Title); Location; Attendee Name(s); Date; Meeting Start Time; Meeting End Time; Agenda Items; Audio Conference dial in info (top or Minutes Module); and Web Conference Link (top or Minutes Module under audio info).

Agenda Items Input

The main input area on this tab allows users to type in a list of Agenda Items for a meeting by adding the same graphic elements before each new item. Once filled out, these agenda items are placed into the meeting invitation that is sent to all invitees. These agenda items are placed directly into the Agenda Items Module when the user opens the MM system application interface for this meeting record.

Web & Audio Conferencing Information

The MM system can denote that the meeting is a web and/or audio conference meeting by allowing users to add a URL (for a web meeting), as well as dial in audio conferencing information for the audio portion of the meeting. Additionally, this info is carried over to the meeting invite that is sent to all attendees. Clicking the meeting's “Send” button closes the meeting record dialog, and then brings the meeting information into MM system to be listed in the dashboard's “Next 5 meetings” area. It also adds Action Item information filled into the MM system tab into to the MM system application interface when it is time for that meeting.

Meeting Record Update Notification

This feature utilizes Outlook's inherent meeting update notification feature to update users of any and all changes made to a MM system meeting record. This feature helps users get a much more clear understanding of what the meeting organizer has changed, and ensure that when any changes are made to the original meeting record, the MM system automatically adds to the meeting request update that is sent by Outlook. In that new Meeting invite (which people must accept again in order to be included), the MM system automatically pulls all changed elements to the top and calls them out in an easily readable section above all of the previously listed information.

Listed Order of Changes

The order of these changes are listed at the top of the meeting update email in a certain order. Assuming changes have been made to all elements of the original meeting invite, each of these items are listed in a specific manner. If individual elements (such as the date, Agenda Items, etc.) have not been changed, they are not listed in the update notification. The list of items that were changed can be listed in the following order: Time/Date of meeting; Participants added/removed; Agenda Items added; Agenda Items removed; Web/Audio conference details; and Notes changes.

Again, these updates are called out at the top of the update email sent by Outlook in a specific way using stylized text and colors to differentiate these changes from the rest of the email that was previously sent. None of the previous information is changed or reworked.

Invite Update History-Multiple Invite Changes

If there is more than one round of changes made to a meeting invite, each new round of updates is successively listed in the top section. All previous changes will be incorporated into the invitation body in a specified “Invite Change History”. This change history lists all changes in the same order as changes are made. Historic changes are listed in the right order, but are listed one after the other, line-by-line because these do not need to be stylized for immediate, easy reading. The Update History is listed, and called out by stylized text, directly below the most recent invite update. When an MS Outlook meeting reminder is sent to attendees before the meeting (at the chosen interval), the MM system will place a logo in the line of the meeting reminder interface after the meeting's listing.

Meeting Interface Templates

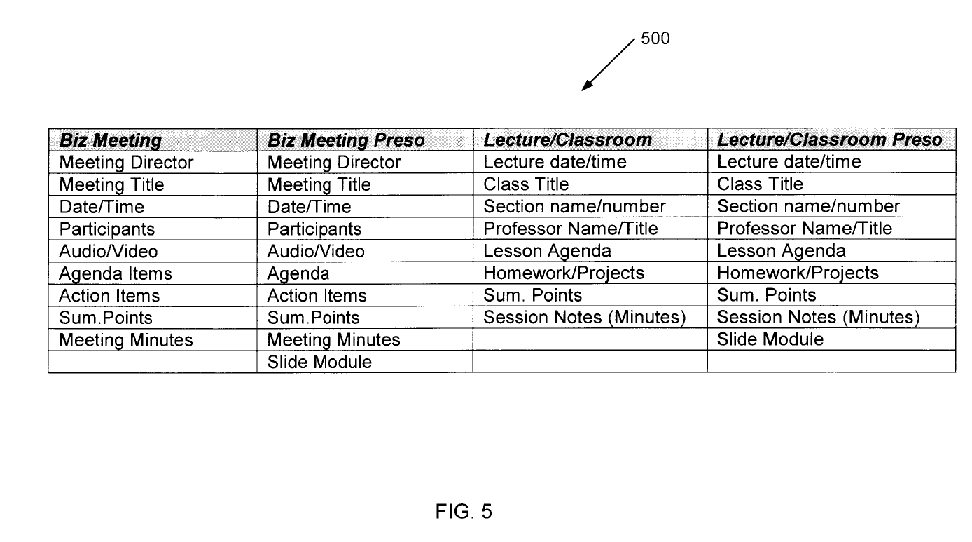

The modules that are displayed on the interface and that are mimicked in the SE can be instantly changed via a number of interface meeting type templates, some of which are listed in the table 500 in FIG. 5. These templates can be set via the set-up Wizard or in the View Menu. Each meeting style template correlates to specific modules (and by design the SE structure) on the application interface. When a template is selected, the interface changes to display the appropriate input fields. These basic settings apply until the user either chooses another interface template layout from the settings menu, or customizes the interface “in-line” by closing or renaming modules. In some embodiments, there are four main template styles. More templates can be used. The following are example templates: Business Meeting; Business Meeting Presentation; Lecture/Classroom Session; and Lecture/Classroom Presentation Session. Again, once the user selects an interface layout, the MM system can completely customize that layout by closing any modules that are not wanted or needed.

Conference Call Support

By utilizing specialized hardware, such as Dynametric's TLP-102 Telephone Recording Adaptor, users can digitally record telephone conferences directly through their PC into their MM system audio recording feature. Thus, the MM system can record and distribute a teleconference meeting simply by a user plugging a phone into their PC through the device. Phone conference meetings work similarly.

Web Conferencing Support

A user can use one of the popular web conferencing solutions to enable the MM system to record (and disseminate) all of the critical elements of a web conference meeting by utilizing the share screen or share application features offered by vendors of these solutions. Thus, while screen sharing, users can use the MM system interface to display all meeting information and can record the meeting as they would when not using their web conferencing product. Thus, at the end of the web conference, a clear, concise wrap-up of the meeting is automatically sent to all meeting attendees. Further, web conferencing support can be found in the MM system's MS Outlook new meeting tab. MM system meetings have a tab in MS Outlook meeting records that will accept the web and audio conferencing information of the meeting. This information is then disseminated to all meeting invitees via the MS Outlook meeting invite email.

Microsoft Word Integration

MS Word integration serves two critical purposes for MM system users. First, it helps bridge the gap between the advanced user and the non-technical user. Second, it allows all users to continue using the programs that they use most, via a known work flow, without forcing a paradigm change or the need to learn new technology. Integration takes the form of an integrated toolbar button and menu item accessed directly from the MS Word interface. The menu item drops down to give users instant access to the following controls: Insert Meeting Director Outline; Export Notes to Meeting Director; Customize Template; Preferences; Help; and About Meeting Director. Each of these items will begin or complete a specific task. Below is an outline of those specific tasks.

Insert Meeting Director Outline

This function instantly inserts a skeleton of the default MM system notes layout. This skeleton includes called out header text and style elements for each note field, list items with differentiated bullets at the start of each field, and starter help text that tells the user what to do in that field. The default skeleton layout include the following fields: Meeting Details; Meeting Agenda; Meeting Summary Points; Action items; Meeting Minutes Users can add or delete any of those elements inserted by the plug-in by using MS Words word processing (delete, etc.). Users can customize what the MM system inserts into a blank Word document as the skeleton.

Export Notes to MM System

Once the layout has been customized to the users satisfaction, and the meeting notes have been input into the appropriate fields provided, the user either navigates to the menu to select Meeting Director>Export Notes, or clicks the Meeting Director toolbar button and chooses the export option. Choosing either of these takes all of the content input into the MS Word interface and exports it into MM system based on the header fields. The user can also set an option in the customization dialog to automatically create a SE from the MS Word content itself.

Customize Notes Template

The customize template option allows users to customize what “notes skeleton” is placed into the blank MS Word document when the Meeting Director button (or menu item) is selected. When users choose this option, the Customization dialog window opens to allow users to select which notes fields/elements they would like to include in the skeleton. Users can choose to include/exclude any combination of the default fields listed above. The first time the Customization dialog is opened, all of the notes fields check boxes are checked (default). Un-checking any of the fields causes those fields to not appear the next time the insert outline button is clicked.

The MM system also includes a number of dialog boxes that can be accessed via menu or representative graphical button. “MeetingDirector Preferences” takes the user to the default preferences dialog box. “MeetingDirector Help” takes the user to the default F1 help dialog box. “About MeetingDirector” take the user to the default About dialog box.

Automatic Archiving System

IT administrators can automatically set up the archive folder/file system for each desktop license they install. This way one location can be chosen and a simple file (i.e. edddXML) can help the IT resource (or end user) installing MM system quickly and easily set a company wide archive.

Reports

The MM system can generate one or more reports per meeting. Reports can be critical tool for users of the system to see the benefits of good meetings, and to track the progress associated with Action Items from a meeting. Reports can also link two or more meetings that are related in any way, i.e. by project, by meeting attendees, by enterprise group, etc. Reports can be configured to provide: a number of meetings (frequency), a percent of overall meetings managed by the MM system; an average number of participants per meeting; an average meeting length; an average number of Action Items assigned; an average number or Action Items completed; and an average number of documents attached per meeting

A report can also be configured to provide a preferred or most popular meeting time or list of times, a Min/Max meeting length, a Min/Max number of participants, a week day choice (as indicated by a percentage of participants, for example), and location choices. Other embodiment of the MM system include a reporting module that generates a report providing: a list of most-used modules (i.e. SE); a percentage of meetings that use an agenda; and a type of web or audio conferencing used and/or a percentage number in which such conferencing was used.

One customized type of report is an Individual Meeting Owner Report. This report will be available with the desktop application, and provides all or most of the items described above, and also a summary of all of those items.

Reports can also be configured to provide an average cost per meeting. Via link to a company's human resources database that includes salary information, the report can feed the human resources database an average salary per title or level of meeting participants. This report feature requires salary data in a file format that is importable into the MM system. Preferably, only high level executives have access to this report feature. To maintain a level of confidentiality, individual data can be suppressed and the report configured to provide only totals and/or averages.

Diagnostics Report

Other report types are possible. A diagnostics report gives an organization insight into how the MM system is being used, over a given date range, and by whom. A machine diagnostics report can be provided on a per user basis. When a user “activates” the MM system, it logs information about the user's computer, including browser version, multimedia player version, and operating system. A best practices report (agenda managed, summary points used, etc.) utilizes meeting expertise to create a report that exposes whether meeting best practices are being used in the organization. For example, the best practices report can help answer what percentage of the organization's meeting are using an agenda.

In still other embodiments, the report can be configured to provide times an archived meeting is accessed; a number of clients deployed, and an export function to XLS (CSV), PDF, or Flash. Role-based permissions can be used to assign report access to individual users, or to expose certain functionality on a “groups” basis. Accessibility can be provided according to several options. In a first option, only reports that reside with the desktop application will be accessible “offline”. In another option, if a report is viewed from the MM system server, the server will cache a copy local that will be accessible “offline” through the MM system application dashboard.

Each report can be validated with a problem statement that a common user would solve with the creation of the report. For instance, an individual user of the MM system may like to know how much time they are spending in meetings. At an organizational level, an executive or manager would like to know how much time is being spent in meetings across the organization, or would like to know the hard cost of meetings within their organization. An IT manager may like to know how many users have access to the MM system, and what the common configurations are.

Embodiments of the MM system and all of the functional operations described in this specification can be implemented in digital electronic circuitry, or in computer software, firmware, or hardware, including the structures disclosed in this specification and their structural equivalents, or in combinations of them. Embodiments of the MM system can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the MM system can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the MM system can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the MM system have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A meeting management system comprising:
a desktop application having a plurality of input modules and a plurality of output modules;
the input modules including a video input, an audio input, and text input;
the output modules including an email output;
the desktop application configured to process video, audio and text related to a meeting from the video input, audio input and text input, and to output a summary email of the meeting to the email output.

2. A system as in claim 1, wherein the desktop application is adapted to display a meeting director application interface, wherein the meeting director application interface includes at least one module containing information related to a meeting.

3. A system as in claim 2, wherein the at least one module includes an agenda module that contains information related to a meeting agenda.

4. A system as in claim 2, wherein the at least one module includes a meeting minutes module adapted to record information related to minutes of a meeting.

5. A system as in claim 1, wherein the at least one module includes a slides module that displays at least one data slide.

6. A system as in claim 1, wherein the application is adapted to permit a user to assign responsibility for at least one action item to at least one meeting attendee.

7. A system as in claim 1, wherein the desktop application is adapted to interface with additional desktop applications selected from the group consisting of a word processing application, a scheduling application, and a multimedia application.

8. A system as in claim 1, wherein the email output is automatically generated at the close of a meeting.

9. A system as in claim 9, wherein the email output includes a meeting summary.

10. A system as in claim 9, wherein the email output includes a list of at least one action item.

11. A system as in claim 9, wherein the email output includes a summary of meeting minutes.

12. A system as in claim 1, wherein the application includes an email summary module that enables a user to format the email output.

13. A system as in claim 1, wherein the email output is automatically sent to all meeting attendees.

14. A system as in claim 1, wherein the application is adapted to record audio.

15. A system as in claim 1, wherein the application is adapted to record video.
